(19) United States
(12) Patent Application Publication
(10) Pub. No.: US 2026/0075307 A1
(43) Pub. Date: Mar. 12, 2026

(54) AUTO-GENERATED PROMPT SYSTEM AND METHOD FOR GUIDING IMAGE CAPTURE

(71) Applicant: Perfect Mobile Corp., New Taipei City (TW)

(72) Inventors: Chia-Che YANG, New Taipei City (TW); Chiao-Yu YANG, Kaohsiung City (TW)

(21) Appl. No.: 19/321,773

(22) Filed: Sep. 8, 2025

Related U.S. Application Data
(60) Provisional application No. 63/692,777, filed on Sep. 10, 2024.
(60) Provisional application No. 63/870,516, filed on Aug. 26, 2025.

(51) Int. Cl. H04N 23/63; G06V 10/70; G06V 20/20; G06V 40/20; H04N 23/60; H04N 23/61

(52) U.S. Cl. CPC H04N 23/632; G06V 10/768; G06V 20/20; G06V 40/23; H04N 23/61; H04N 23/635; H04N 23/64

(57) ABSTRACT

A computing device detects initiation of an image capture session corresponding to operation of an image capture device, detects at least one target object in a field of view of the image capture device, and extracts contextual cues relating to the at least one target object. User input characterizing a desired resulting image capturing the at least one target object is obtained. The computing device generates at least one real-time prompt based on the contextual cues and the user input, the at least one real-time prompt guiding behavior of the user to achieve at least one target condition. User behavior relating to operation of the image capture device is detected, and additional real-time prompts based on the user behavior are generated. When at least one target condition is met, a final prompt is generated that instructs the user to capture an image of the at least one target object.

### CROSS-REFERENCE TO RELATED APPLICATION

This application claims priority to, and the benefit of, U.S. Provisional Patent Application entitled, “AI Photo Tutor,” having Ser. No. 63/692,777, filed on Sep. 10, 2024, and U.S. Provisional Patent Application entitled, “AI Photo Editing Tutor,” having Ser. No. 63/870,516, filed on Aug. 26, 2025, which are incorporated by reference in their entireties.

### TECHNICAL FIELD

The present disclosure generally relates to systems and methods for providing auto-generated prompts to guide image capture.

### SUMMARY

In accordance with one embodiment, a computing device detects initiation of an image capture session corresponding to operation of an image capture device and detects at least one target object in a field of view of the image capture device. The computing device extracts contextual cues relating to the at least one target object and obtains user input characterizing a desired resulting image capturing the at least one target object. The computing device generates at least one real-time prompt based on the contextual cues and the user input, the at least one real-time prompt guiding behavior of the user to achieve at least one target condition. The computing device detects user behavior relating to operation of the image capture device and generates additional real-time prompts based on the user behavior. When at least one target condition is met, the computing device generates a final prompt instructing the user to capture an image of the at least one target object with the image capture device.

Another embodiment is a system that comprises a memory storing instructions and a processor coupled to the memory. The processor is configured to detect initiation of an image capture session corresponding to operation of an image capture device and detect at least one target object in a field of view of the image capture device. The processor is further configured to extract contextual cues relating to the at least one target object and obtain user input characterizing a desired resulting image capturing the at least one target object. The processor is further configured to generate at least one real-time prompt based on the contextual cues and the user input, the at least one real-time prompt guiding behavior of the user to achieve at least one target condition. The processor is further configured to detect user behavior relating to operation of the image capture device and generate additional real-time prompts based on the user behavior. When at least one target condition is met, the processor is further configured to generate a final prompt instructing the user to capture an image of the at least one target object with the image capture device.

Another embodiment is a non-transitory computer-readable storage medium storing instructions to be executed by a computing device. The computing device comprises a processor, wherein the instructions, when executed by the processor, cause the computing device detect initiation of an image capture session corresponding to operation of an image capture device and detect at least one target object in a field of view of the image capture device. The processor is further configured by the instructions to extract contextual cues relating to the at least one target object and obtain user input characterizing a desired resulting image capturing the at least one target object. The processor is further configured by the instructions to generate at least one real-time prompt based on the contextual cues and the user input, the at least one real-time prompt guiding behavior of the user to achieve at least one target condition. The processor is further configured by the instructions to detect user behavior relating to operation of the image capture device and generate additional real-time prompts based on the user behavior. When at least one target condition is met, the processor is further configured by the instructions to generate a final prompt instructing the user to capture an image of the at least one target object with the image capture device.

Other systems, methods, features, and advantages of the present disclosure will be apparent to one skilled in the art upon examining the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure are better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a computing device configured to provide auto-generated prompts for guiding image capture according to various embodiments of the present disclosure.

FIG. 2 is a schematic diagram of the computing device of FIG. 1 in accordance with various embodiments of the present disclosure.

FIG. 3 is a top-level flowchart illustrating examples of functionality implemented as portions of the computing device of FIG. 1 for providing auto-generated prompts for guiding image capture according to various embodiments of the present disclosure.

FIG. 4 illustrates an image capture session performed by the computing device of FIG. 1 according to various embodiments of the present disclosure.

FIG. 5 illustrates the contextual cue extractor of FIG. 1 identifying target objects within the field of view of the image capture device according to various embodiments of the present disclosure.

FIG. 6 provides examples of contextual cues associated with the target objects according to various embodiments of the present disclosure.

FIG. 7 illustrates the computing device of FIG. 1 obtaining a description of a desired resulting image from the user according to various embodiments of the present disclosure.

FIG. 8 illustrates an example of real-time prompts generated by the guidance module of FIG. 1 based on the contextual cues and the user input according to various embodiments of the present disclosure.

FIG. 9 illustrates the guidance module of FIG. 1 generating a final prompt instructing the user to capture an image of the target objects using the image capture device according to various embodiments of the present disclosure.

### DETAILED DESCRIPTION

The subject disclosure is now described with reference to the drawings, where like reference numerals are used to refer to like elements throughout the following description. Other aspects, advantages, and novel features of the disclosed subject matter will become apparent from the following detailed description and corresponding drawings.

Although image capture devices are ubiquitous and the capabilities of image capture devices are constantly improving, it can be challenging for individuals who lack in depth knowledge of photography skills to capture high quality images similar to those captured by professional photographers. Selecting the optimal settings for such parameters as the shutter speed, aperture, ISO, etc. can be difficult for individuals who lack the expertise.

Embodiments are disclosed for an intelligent image capture guidance system and method for assisting users in capturing high quality photographs by providing real-time guidance and feedback. Implementation of various embodiments achieve significant improvement in the technical field of digital photography by introducing real-time user feedback based on analysis of contextual cues extracted from a field of view of the image capture device, thereby addressing challenges related to the lack of technical knowledge for capturing high-end images. Embodiments leverage the use of artificial intelligence (AI) to enhance the resulting images captured by the image capture device.

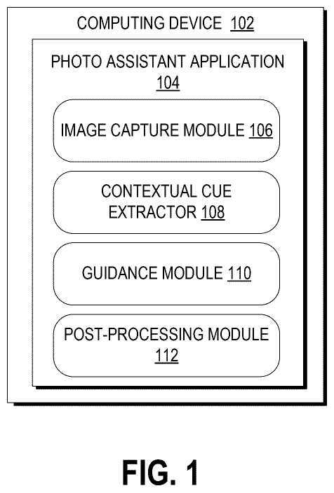

A system for providing auto-generated prompts for guiding image capture based on contextual cues is described followed by a discussion of the operation of the components within the system. FIG. 1 is a block diagram of a computing device 102 in which the embodiments disclosed herein may be implemented. The computing device 102 may comprise one or more processors that execute machine executable instructions to perform the features described herein. For example, the computing device 102 may be embodied as a computing device such as, but not limited to, a smartphone, a tablet-computing device, a laptop, and so on.

A photo assistant application 104 executes on a processor of the computing device 102 and includes an image capture module 106, a contextual cue extractor 108, a guidance module 110, and a post-processing module 112. The image capture module 106 is executed on a processor of the computing device 102 to detect initiation of an image capture session for capturing images or videos, where the image capture session is carried out through operation of a rear-facing camera or other image capture device of the computing device 102 or image capture device communicatively coupled to the computing device 102. In some implementations, the computing device 102 may be equipped with the capability to connect to the Internet, and the image capture module 106 may be configured to operate a remote device equipped with a camera to obtain images or videos.

The images captured or obtained by the image capture module 106 may be encoded in any of a number of formats including, but not limited to, JPEG (Joint Photographic Experts Group) files, TIFF (Tagged Image File Format) files, PNG (Portable Network Graphics) files, GIF (Graphics Interchange Format) files, BMP (bitmap) files or any number of other digital formats. The videos may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), 360 degree video, 3D scan model, or any number of other digital formats.

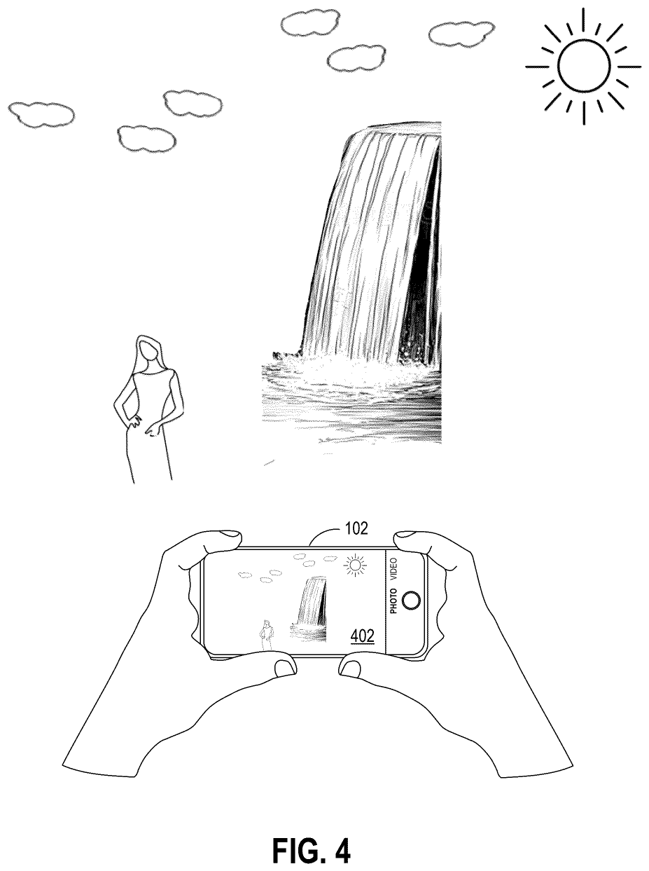

To further illustrate functionality of the image capture module 106, reference is made to FIG. 4, which shows an image capture session performed by the computing device 102. For some embodiments, the user utilizes a user interface 402 displaying the field of view of the image capture device to conduct the image capture session where the field of view corresponds to the viewable area captured by the lens system of the image capture device. The image capture module 106 detects when the user initiates an image capture session and communicates detection of this event to the contextual cue extractor 108 (FIG. 1). This may comprise, for example, detecting when the user selects a camera application on the home screen displayed on the computing device 102 and when the user selects a camera mode once the camera application executes.

Referring back to FIG. 1, the contextual cue extractor 108 is executed by the processor of the computing device 102 to detect one or more target objects present in the field of view of the image capture device. Upon detecting that an image capture session has been initiated by the user, the image capture module 106 communicates with the contextual cue extractor 108, which then identifies one or more target objects depicted in the field of view.

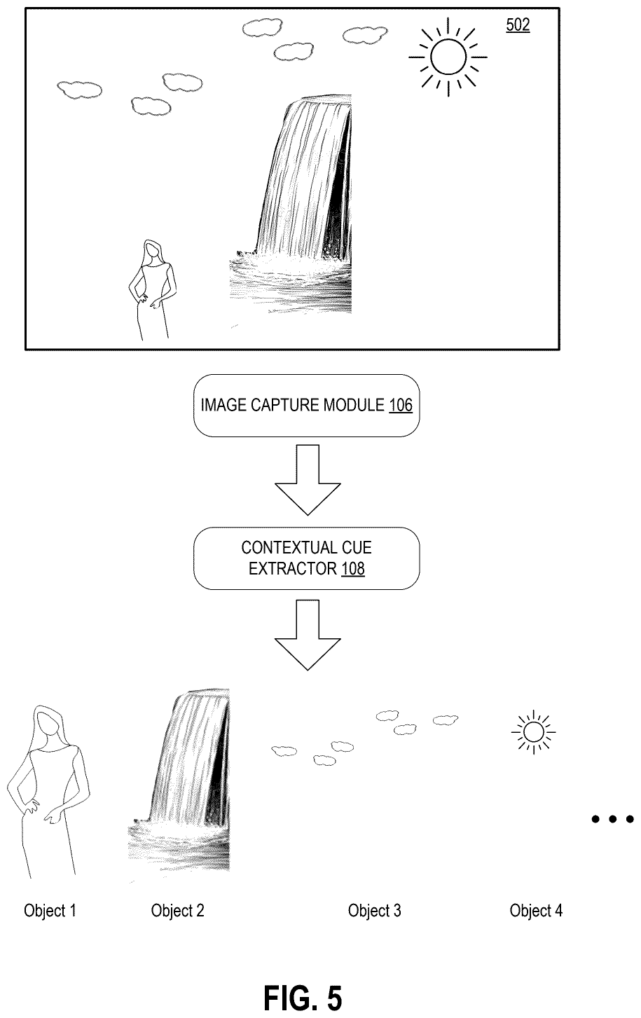

To illustrate, reference is made to FIG. 5. In the example shown, the target objects detected in the field of view 502 of the image capture device comprise an individual and scenery objects such as a waterfall, clouds, the sun, and so on. The contextual cue extractor 108 then derives contextual cues relating to the detected target objects, where the contextual cues provide, for example, information relating to visual elements in the field of view of the image capture device and provide context of the scenery being shown on the computing device 102. The contextual cues may also provide context relating to the time of day, event, mood of individuals shown in the field of view, and so on.

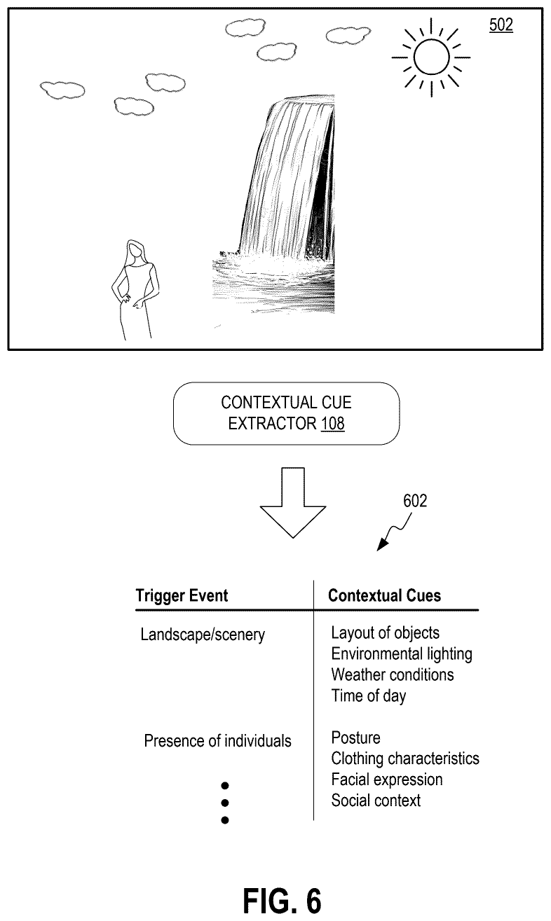

Continuing to FIG. 6, the contextual cue extractor 108 derives contextual cues 602 from the field of view 502 of the image capture device based on the detection of trigger events. In some embodiments, trigger events may comprise, for example, the presence of landscape/scenery including trees, mountains, lakes, and so on. Other trigger events may comprise the presence of individuals in the field of view. The contextual cue extractor 108 derives contextual cues associated with each trigger event.

As shown earlier in FIG. 5, the contextual cue extractor 108 detects the presence of scenery objects comprising, for example, a waterfall, clouds, the sun, and so on. Based on this, the contextual cue extractor 108 derives information relating to the relative layout of the objects, the environmental lighting, weather conditions, the time of day, and so on. As further shown in FIG. 6, the contextual cue extractor 108 also detects the presence of an individual in the field of view. Based on this, the contextual cue extractor 108 derives information relating to the posture of the individual, clothing worn by the individual, the individual's facial expression, whether the individual is interacting with other individuals, and so on.

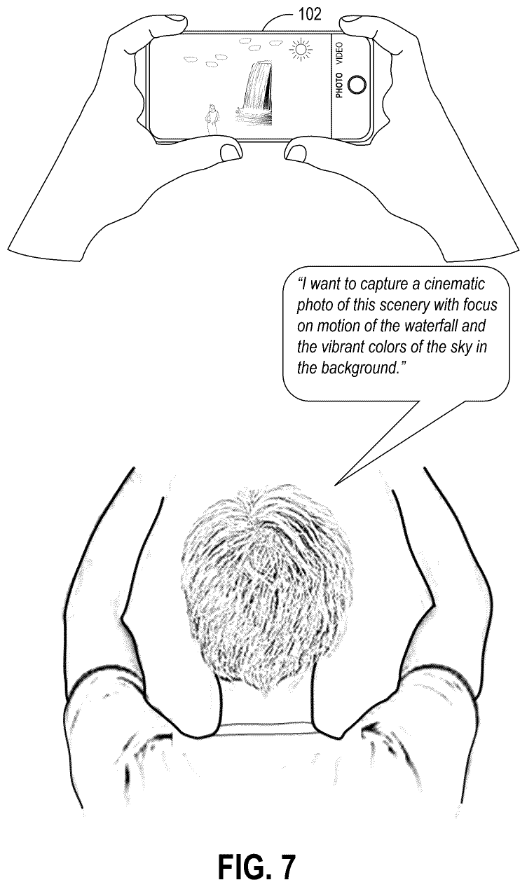

Referring back to the system diagram of FIG. 1, the photo assistant application 104 includes a guidance module 110 configured to obtain input from the user describing a desired resulting image depicting the one or more target objects shown in the field of view of the image capture device. The user may specify the desired resulting image capturing through the use of an input device such as a touchscreen interface or by describing the desired resulting image to the computing device 102, which receives the input in this case through a built-in microphone. In the example shown in FIG. 7, the user verbally describes a desired result to the computing device 102.

To achieve the desired result specified by the user, the guidance module 110 utilizes an artificial intelligence (AI) model trained by a collection of samples images comprising, for example, images captured by professional photographers, highly-rated images on social media, and so on. During a training phase, the guidance module 110 processes the collection of sample images and analyzes image capture device operation settings and corresponding contextual cues associated with each sample image. In some embodiments, the guidance module 110 identifies prominent features depicted in each sample image by applying photo composition techniques, lighting analysis, edge detection, semantic segmentation, detection models, digital signal processing, and other techniques.

The guidance module 110 utilizes the extracted information to train the AI model, which may group the collection of sample images into different clusters based on similarity of prominent features, image capture device settings, and so on. The guidance module 110 identifies a closest matching cluster of sample images based on the content depicted in the field of view of the image capture device and based on the desired resulting image verbally described by the user.

As the image capture device operation settings may vary significantly across the sample images in a closest matching cluster, the guidance module 110 may sort or prioritize image capture device operation settings according to the degree of difficulty or complexity for the user to set. For some embodiments, the image capture device operation settings with the highest priority may be presented to the user to serve as guidance on how to achieve the desired look specified by the user.

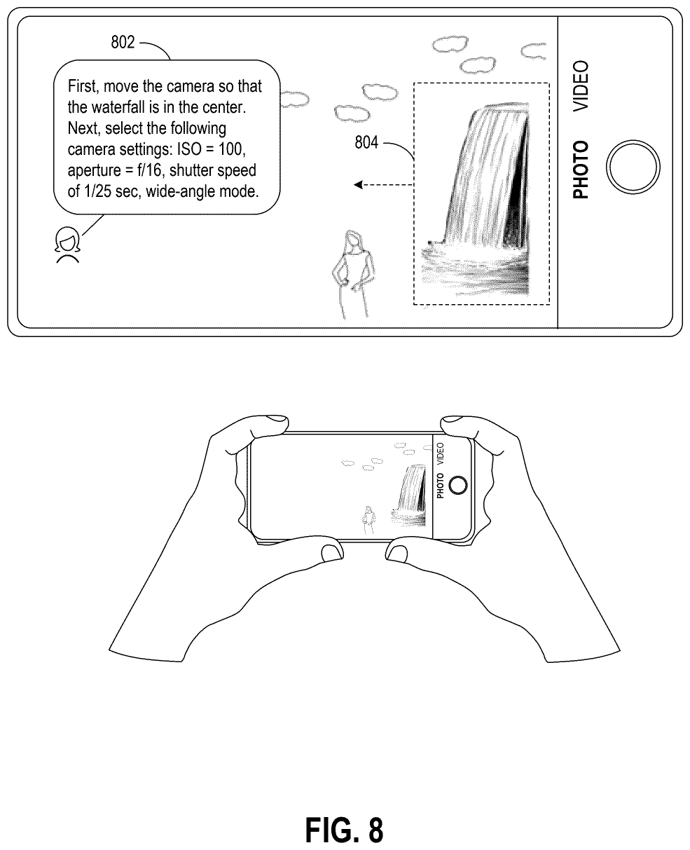

FIG. 8 illustrates an example of real-time prompts generated by the guidance module 110 based on the contextual cues and the input provided earlier by the user relating to a desired resulting image. For some embodiments, the real-time prompts guide the user to achieve at least one target condition, where the guidance module 110 monitors the user's behavior to determine whether any target conditions are met. The target conditions may comprise the user adjusting specific operation settings of the image capture device, as directed by the guidance module 110 using the real-time prompts.

In the example shown, one of the real-time prompts displayed to the user comprises textual instructions 802 guiding the user on how to position the image capture device. The textual instructions 802 also guide the user to set specific operation settings for the image capture device. Note that the real-time prompts may also comprise graphical cues provided to the user such as grid lines or other graphical elements displayed in the user interface that highlight one or more target objects. In the example shown in FIG. 8, one of the real-time prompts comprises a box and arrow 804 around the water fall object that guides the user on how to reposition the image capture device so that the water fall is centered in the field of view.

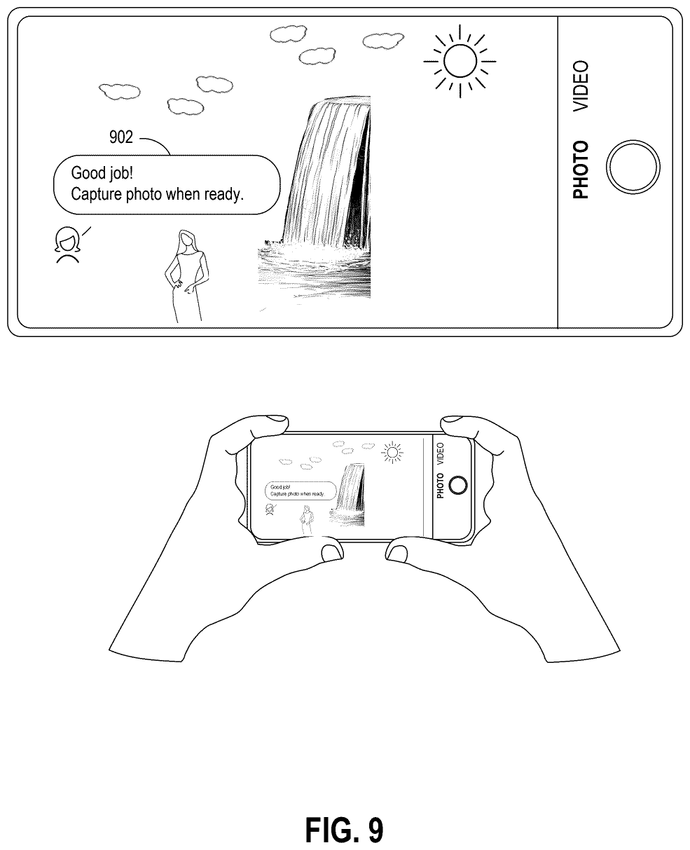

FIG. 9 illustrates additional functionality of the guidance module 110. For some embodiments, the guidance module 110 detects when at least one target condition is met and generates a final prompt instructing the user to capture an image of the target objects using the image capture device if a threshold number of target conditions are met. For example, if suggested positioning of target objects in the field of view of the image capture device is not met but all the operating settings of the image capture device are satisfactorily adjusted, the guidance module 110 may alert the user that an image is ready to be captured. In other instances, however, additional real-time prompts may be generated by the guidance module 110 to achieve the threshold number of target conditions. Responsive to the final prompt, the user captures a resulting image as directed by the guidance module 110.

In some instances, the resulting image captured by the user may not meet the user's desired expectations. Referring back to the system diagram in FIG. 1, the photo assistant application 104 may further comprise a post-processing module 112 configured to perform touch-ups and other modifications to more closely align with the criteria specified by the user. For some embodiments, the post-processing module 112 communicates with the AI model of the guidance module 110 to assist in automatically editing the captured image to generate a modified resulting image.

For some embodiments, the post-processing module 112 is configured to perform post-processing on the captured image utilizing a generative AI model based on the contextual cues extracted by the contextual cue extractor 108. For some embodiments, the contextual cue extractor 108 applies a visual-language model (VLM) to extract the contextual cues from the captured image and obtains an aesthetic rule describing a desired post-processing result. The post-processing module 112 generates editing prompts based on the contextual cues and the aesthetic rule and inputs the editing prompts into the generative AI model to output a modified captured image. The post-processing module 112 may perform the operations described above over multiple iterations, depending on whether the user wishes to further refine the captured image. The aesthetic rule describing the desired post-processing result may comprise user input in the form of textual description or other form of user input. The aesthetic rule may also comprise a pre-defined rule that specifies the desired post-processing result.

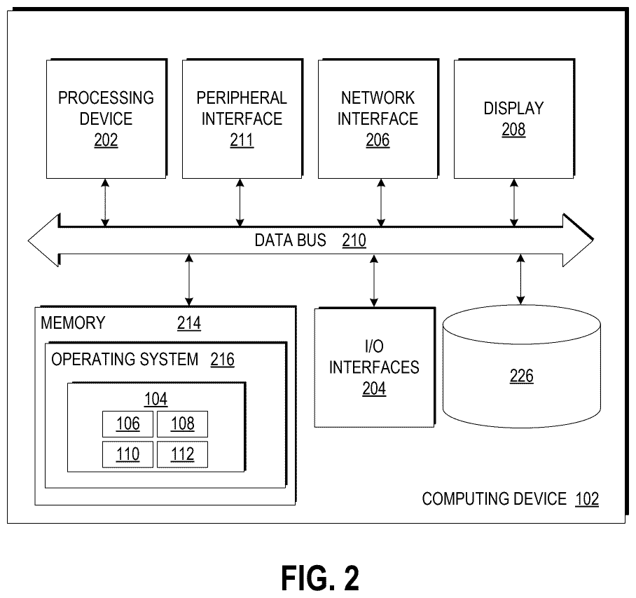

FIG. 2 illustrates a schematic block diagram of the computing device 102 in FIG. 1. The computing device 102 may be embodied as a desktop computer, portable computer, dedicated server computer, multiprocessor computing device, smart phone, tablet, and so forth. As shown in FIG. 2, the computing device 102 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the computing device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM) such as DRAM and SRAM) and nonvolatile memory elements (e.g., ROM, hard drive, tape, CDROM). The memory 214 typically comprises a native operating system 216, one or more native applications, emulation systems, or emulated applications for any of a variety of operating systems and/or emulated hardware platforms, emulated operating systems, etc. For example, the applications may include application specific software that may comprise some or all the components of the computing device 102 displayed in FIG. 1.

In accordance with such embodiments, the components are stored in memory 214 and executed by the processing device 202, thereby causing the processing device 202 to perform the operations/functions disclosed herein. For some embodiments, the components in the computing device 102 may be implemented by hardware and/or software.

Input/output interfaces 204 provide interfaces for the input and output of data. For example, where the computing device 102 comprises a personal computer, these components may interface with one or more input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

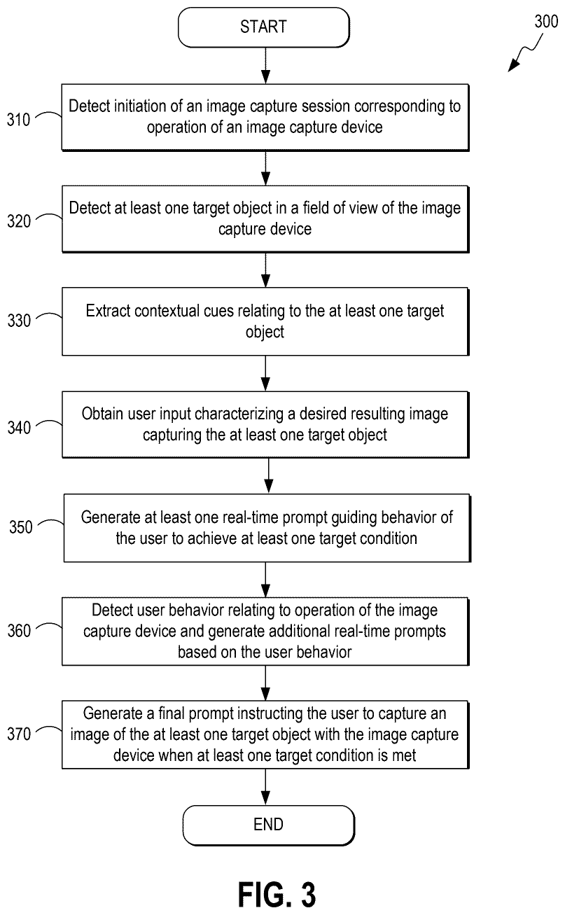

Reference is made to FIG. 3, which is a flowchart 300 in accordance with various embodiments for providing auto-generated prompts for guiding photo capture, where the operations are performed by the computing device 102 of FIG. 1. It is understood that the flowchart 300 of FIG. 3 provides merely an example of the different types of functional arrangements that may be employed to implement the operation of the various components of the computing device 102. As an alternative, the flowchart 300 of FIG. 3 may be viewed as depicting an example of steps of a method implemented in the computing device 102 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. In addition, two or more blocks shown in succession in FIG. 3 may be executed concurrently or with partial concurrence. It is understood that all such variations are within the scope of the present disclosure.

At block 310, the computing device 102 detects initiation of an image capture session corresponding to operation of an image capture device. At block 320, the computing device 102 detects one or more target objects in a field of view of the image capture device. The target objects detected in the field of view of the image capture device comprise individuals, scenery objects, man-made structures, and so on.

At block 330, the computing device 102 extracts contextual cues relating to the one or more target objects identified in block 320. For some embodiments, the computing device 102 extracts the contextual cues by first classifying each target object into a pre-defined object category (e.g., man-made structure). The contextual cues provide information relating to visual elements in the field of view of the image capture device and provide context of the scenery being shown on the computing device 102. For example, the contextual cues may provide context relating to the time of day, event, and mood of individuals shown in the field of view. The contextual cues may also provide information relating to the positioning and people, objects, and so on. The contextual cues may also provide information relating to the relative size and proportions between people and objects within the image. As another example, the contextual cues may correspond to environmental conditions surrounding the one or more target objects, where the environmental conditions comprise background objects and/or environmental lighting.

At block 340, the computing device 102 obtains user input characterizing a desired resulting image capturing the one or more target objects identified in block 320. The user may specify the desired resulting image capturing through the use of an input device such as a touchscreen interface or by describing the desired resulting image to the computing device 102, which receives the input in this case through a built-in microphone.

At block 350, the computing device 102 generates one or more real-time prompts based on the contextual cues and the user input, where the real-time prompts guide behavior of the user to achieve at least one target condition. The real-time prompts may comprise, for example, a prompt displayed in a user interface on the computing device, a graphical element highlighting the least one target object in the user interface on the computing device, an overlay chart displayed in the user interface on the computing device for adjusting a field of view of the image capture device and/or a voice prompt output by the computing device 102. The real-time prompts may comprise, for example, instructions on how to orient the camera, set the zoom level of the camera, enable camera flash, set such camera parameters as the exposure level, and so on. Such instructions may be conveyed to the user using, for example, silhouette maps and anchor points displayed to the user.

For some embodiments, the computing device 102 utilizes an AI model to generate the one or more real-time prompts. The AI model is trained by a collection of samples images comprising, for example, images captured by professional photographers, highly-rated images on social media and so on. The computing device 102 processes the collection of sample images and analyzes image capture device operation settings and corresponding contextual cues associated with each sample image. The one or more target conditions may comprise the user adjusting the image capture device according to suggested operation settings provided by the computing device.

At block 360, the computing device 102 detects user behavior relating to operation of the image capture device and generates additional real-time prompts based on the user behavior. For example, additional real-time prompts may be needed to further guide the user in some instances. At block 370, the computing device 102 generates a final prompt instructing the user to capture an image of the one or more target objects with the image capture device when at least one of the target condition is met.

For some embodiments, the computing device 102 performs post-processing on the captured image of the one or more target objects, where the post-processing is performed utilizing generative AI model based on contextual cues extracted from the captured image. For some embodiments, the post-processing performed by the computing device 102 comprises applying a visual-language model (VLM) to extract the contextual cues from the captured image and obtaining an aesthetic rule describing a desired post-processing result. The post-processing feature further comprises generating editing prompts based on the contextual cues and the aesthetic rule and inputting the editing prompts into the generative AI model and outputting a modified captured image. The aesthetic rule describing the desired post-processing result may comprise user input or a pre-defined rule. In some instances, the user may wish to further refine the modified captured image. In such instances, the computing device 102 obtains user input comprising a new aesthetic rule for refining the modified captured image and generates new editing prompts based on the contextual cues and the new aesthetic rule. The new editing prompts are input into the generative AI model and another modified captured image is output by the computing device 102.

In some embodiments, the AI model is further configured to dynamically update real-time prompts based on analysis of user behavior during the image capture session. For instance, if the computing device 102 detects that the user repeatedly tilts the image capture device in a manner inconsistent with the suggested orientation, the AI model may adjust subsequent prompts to provide alternative guidance more suitable to the user's behavior. Similarly, if hand tremors or device shaking are detected, the AI model may adapt the prompts to suggest enabling image stabilization features or leaning the device against a fixed surface.

In some embodiments, the post-processing module 112 may generate an aesthetic rule without direct user input by leveraging external data sources. For example, the post-processing module 112 may automatically extract stylistic trends from highly-rated social media images, recent photography competitions, or predefined aesthetic templates to create a contextually appropriate rule. The generated aesthetic rule may specify enhancements such as skin smoothing, brightness adjustments, or background blurring, which are then translated into editing prompts for the generative AI model.

In further embodiments, the computing device 102 is not limited to smartphones, tablets, or laptops, but may also include wearable devices such as augmented reality (AR) glasses, virtual reality (VR) headsets, or smart eyewear equipped with image capture functionality. When implemented in such wearable devices, the real-time prompts may be displayed directly in the user's field of view via a heads-up display, and voice prompts may be delivered through integrated audio systems. Such embodiments expand the scope of applications to hands-free photography, immersive video capture, and live-streaming scenarios. Thereafter, the process in FIG. 3 ends.

The embodiments described above in the present disclosure are possible examples of implementations set forth for an understanding of the principles of the disclosure. Variations and modifications may be made to the one or more embodiments described herein without departing substantially from the spirit and principles of the disclosure. All such modifications and variations are included herein within the scope of this disclosure and protected by the following claims.

1. A method implemented in a computing device, comprising:
detecting initiation of an image capture session corresponding to operation of an image capture device by a user;
detecting at least one target object in a field of view of the image capture device;
extracting contextual cues relating to the at least one target object;
obtaining user input characterizing a desired resulting image capturing the at least one target object;
generating at least one real-time prompt based on the contextual cues and the user input, the at least one real-time prompt guiding behavior of the user to achieve at least one target condition;
detecting user behavior relating to operation of the image capture device and generating additional real-time prompts based on the user behavior;
when at least one target condition is met, generating a final prompt instructing the user to capture an image of the at least one target object with the image capture device.

2. The method of claim 1, wherein the at least one real-time prompt comprises at least one of: a prompt displayed in a user interface on the computing device; a graphical element highlighting the least one target object in the user interface on the computing device; an overlay chart displayed in the user interface on the computing device for adjusting a field of view of the image capture device; or a voice prompt output by the computing device.

3. The method of claim 1, wherein the at least one target condition comprises operation settings of the image capture device being set the user.

4. The method of claim 1, wherein the at least one real-time prompt is generated by an artificial intelligence (AI) model trained by analyzing image capture device operation settings and corresponding contextual cues.

5. The method of claim 1, wherein extracting the contextual cues relating to the at least one target object comprises detecting environmental conditions surrounding the at least one target object, wherein the environmental conditions comprise at least one of: background objects or environmental lighting.

6. The method of claim 1, wherein extracting the contextual cues relating to the at least one target object comprises classifying the at least one target object into a pre-defined object category.

7. The method of claim 1, further comprising performing post-processing on the captured image of the at least one target object, wherein the post-processing is performed utilizing a generative artificial intelligence (AI) model based on contextual cues extracted from the captured image.

8. The method of claim 7, wherein post-processing on the captured image comprises:
applying a visual-language model (VLM) to extract the contextual cues from the captured image;
obtaining an aesthetic rule describing a desired post-processing result;
generating editing prompts based on the contextual cues and the aesthetic rule;
inputting the editing prompts into the generative AI model and outputting a modified captured image.

9. The method of claim 8, wherein the aesthetic rule describing the desired post-processing result comprises one of: user input or a pre-defined rule.

10. The method of claim 8, further comprising:
obtaining user input comprising an additional aesthetic rule for refining the modified captured image;
generating new editing prompts based on the contextual cues and the additional aesthetic rule; and
inputting the new editing prompts into the generative AI model and outputting another modified captured image.

11. A system, comprising:
a memory storing instructions;
a processor coupled to the memory and configured by the instructions to at least:
detect initiation of an image capture session corresponding to operation of an image capture device by a user;
detect at least one target object in a field of view of the image capture device;
extract contextual cues relating to the at least one target object;
obtain user input characterizing a desired resulting image capturing the at least one target object;
generate at least one real-time prompt based on the contextual cues and the user input, the at least one real-time prompt guiding behavior of the user to achieve at least one target condition;
detect user behavior relating to operation of the image capture device and generating additional real-time prompts based on the user behavior;
when at least one target condition is met, generate a final prompt instructing the user to capture an image of the at least one target object with the image capture device.

12. The system of claim 11, wherein the at least one real-time prompt comprises at least one of: a prompt displayed in a user interface on the system; a graphical element highlighting the at least one target object in the user interface on the system; an overlay chart displayed in the user interface on the system for adjusting a field of view of the image capture device; or a voice prompt output by the system.

13. The system of claim 11, wherein the at least one target condition comprises operation settings of the image capture device being set the user.

14. The system of claim 11, wherein the at least one real-time prompt is generated by an artificial intelligence (AI) model trained by analyzing image capture device operation settings and corresponding contextual cues.

15. The system of claim 11, wherein the processor is configured to extract the contextual cues relating to the at least one target object by detecting environmental conditions surrounding the at least one target object, wherein the environmental conditions comprise at least one of: background objects or environmental lighting.

16. The system of claim 11, wherein the processor is configured to extract the contextual cues relating to the at least one target object by classifying the at least one target object into a pre-defined object category.

17. A non-transitory computer-readable storage medium storing instructions to be implemented by a computing device having a processor, wherein the instructions, when executed by the processor, cause the computing device to at least:
detect initiation of an image capture session corresponding to operation of an image capture device by a user;
detect at least one target object in a field of view of the image capture device;
extract contextual cues relating to the at least one target object;
obtain user input characterizing a desired resulting image capturing the at least one target object;
generate at least one real-time prompt based on the contextual cues and the user input, the at least one real-time prompt guiding behavior of the user to achieve at least one target condition;
detect user behavior relating to operation of the image capture device and generating additional real-time prompts based on the user behavior;
when at least one target condition is met, generate a final prompt instructing the user to capture an image of the at least one target object with the image capture device.

18. The non-transitory computer-readable storage medium of claim 17, wherein the at least one real-time prompt comprises at least one of: a prompt displayed in a user interface on the computing device; a graphical element highlighting the least one target object in the user interface on the computing device; an overlay chart displayed in the user interface on the computing device for adjusting a field of view of the image capture device; or a voice prompt output by the computing device.

19. The non-transitory computer-readable storage medium of claim 17, wherein the at least one target condition comprises operation settings of the image capture device being set the user.

20. The non-transitory computer-readable storage medium of claim 17, wherein the at least one real-time prompt is generated by an artificial intelligence (AI) model trained by analyzing image capture device operation settings and corresponding contextual cues.
